(19) United States
(12) Patent Application Publication
(10) Pub. No.: US 2023/0391242 A1
(43) Pub. Date: Dec. 7, 2023

(54) MOUNTING OF A DUMP BODY TO A TRUCK

(71) Applicant: INDUSTRIES FABKOR INC., Saint-Gabriel-de-Brandon (CA)

(72) Inventor: Benoit LEMAIRE, St-Jean-de-Matha (CA)

(21) Appl. No.: 18/033,146

(22) PCT Filed: Oct. 22, 2021
(86) PCT No.: PCT/IB21/59776

§ 371 Date: Apr. 21, 2023

Related U.S. Application Data
(60) Provisional application No. 63/104,890, filed on Oct. 23, 2020.

(51) Int. Cl. B60P 1/28

(52) U.S. Cl. CPC B60P 1/283

(57) ABSTRACT

A dump body pivotally connected to a subframe mounted on a chassis of a truck. The dump body has a floor and at least one mount connected to an underside of the floor, and the at least one mount defines a channel having an open end. The truck further has a dump body lifting assembly operatively connected between the subframe and the dump body for pivoting the dump body relative to the subframe, the dump body lifting assembly having a connecting member received in the open end of the channel. A method of assembling the dump body to the subframe is also provided.

### CROSS-REFERENCE TO RELATED APPLICATION

The present application claims priority to U.S. Provisional Patent Application No. 63/104,890, filed Oct. 23, 2020, the entirety of which is incorporated herein by reference.

### FIELD OF TECHNOLOGY

The present technology relates to dump bodies, trucks having a dump body, and to methods of assembling a dump body to a truck.

### BACKGROUND

Trucks having dump bodies are used for the transport of different materials, such as rocks, soil, sand, snow and the like. These dump bodies are pivotable relative to the truck chassis to allow for their content to be emptied. The dump body is pivotable about the truck chassis via a hinge assembly that is connected between the dump body and the truck chassis. The hinge assembly is typically located at the rear of the dump body and the truck chassis. A dump body lifting assembly is used to pivot the dump body relative to the truck chassis, and is typically located at the front of the dump body or under the dump body.

When installing a dump body on a truck chassis, the hinge assembly is provided as a unit that has to be connected to the chassis and to the dump body, and then the dump body lifting assembly is operatively connected between the truck chassis and the dump body. In certain situations, several adjustments are needed when connecting the hinge assembly to the dump body and to the truck chassis, and/or when installing the dump body lifting assembly, which leads to increased assembly times.

There is therefore a desire for improvements in the way dump bodies are assembled to a truck chassis and connected to dump body lifting assemblies.

### SUMMARY

It is an object of the present technology to ameliorate at least some of the inconveniences present in the prior art.

In some circumstances, the present technology facilitates the assembly of a dump body on a subframe that is then connectable to the chassis of a truck compared to conventional assemblies and methods. The present technology provides that a connecting member of a dump body lifting assembly is connected to at least one mount connected to an underside of a floor of the dump body. More particularly, the connecting member is received in an open end of a channel defined by the at least one mount. The connecting member can be slid from the open end of the channel to a closed end of the channel until the connecting member abuts the closed end. The connecting member being slidingly received in the channel defined by the at least one mount facilitates the assembly and fitting of the dump body to the subframe. The subframe is then connectable to the chassis of a truck.

Furthermore, the present technology provides that the components of the hinge assembly used to pivotally connect the dump body to the subframe are connected in part on the dump body and in part on the subframe, and then assembled to pivotally connect the dump body to the subframe. In some circumstances, these features facilitate the assembly of the dump body on the subframe, reduce the number of parts required for the assembly, and reduce the time required for assembling and facilitate fitting a dump body to a subframe.

These features and additional features of the present technology will be described in more details below.

In accordance with one aspect of the present technology, there is provided a dump body including a floor, a front wall projecting upwardly from a front end of the floor, a left side wall projecting upwardly from a left side of the floor, a right side wall projecting upwardly from a right side of the floor, and at least one mount connected to an underside of the floor. The at least one mount defines a channel having an open end. The channel is adapted for receiving a connecting member of a dump body lifting assembly.

In some embodiments, the at least one mount is C-shaped.

In some embodiments, the at least one mount is adapted to slidingly receive the connecting member of the dump body lifting assembly.

In some embodiments, the channel is open-ended in a direction pointing generally towards a rear end of the floor.

In some embodiments, the at least one mount is disposed longitudinally between the front end and the rear end of the floor.

In some embodiments, the dump body further includes a lubrication fitting connected to the at least one mount, the lubrication fitting being adapted for injecting lubricant in the channel.

In some embodiments, the dump body further includes a safety pin connectable to the at least one mount to close the channel and secure the connecting member of the dump body lifting assembly in the channel when received therein.

In some embodiments, the safety pin is a fastener.

In some embodiments, the at least one mount includes a first mount and a second mount. The channel of the first mount is a first channel. The channel of the second mount is a second channel. The first and second mounts are laterally spaced from each other on the underside of the floor. The connecting member is received in both the first and second channels.

In some embodiments, the dump body further includes a first longsill connected to the underside of the floor, and a second longsill connected to the underside of the floor. The first and second longsills are laterally spaced from each other. The first mount is connected to an inwardly facing side of the first longsill. The second mount is connected to an inwardly facing side of the second longsill.

In some embodiments, the dump body further includes a hinge assembly including at least one hinge pin, and at least one sill connected to the underside of the floor. The at least one sill defines an aperture dimensioned for receiving the at least one hinge pin therein.

In some embodiments, the at least one sill defines a lubrication port.

In some embodiments, the at least one sill is two sills.

In accordance with another aspect of the present technology, there is provided a truck including a chassis, a cab connected to the chassis, a plurality of wheels rotatably connected to the chassis, a subframe connected to the chassis, the subframe having at least one hinge bracket, and a dump body pivotally connected to the subframe at a rear thereof. The dump body has a floor, a front wall projecting upwardly from a front end of the floor, a left side wall projecting upwardly from a left side of the floor, a right side wall projecting upwardly from a right side of the floor, and at least one mount connected to an underside of the floor, the at least one mount defining a channel having an open end. The truck further includes a dump body lifting assembly operatively connected between the subframe and the dump body for pivoting the dump body relative to the subframe. The dump body lifting assembly has a connecting member received in the channel of the at least one mount.

In some embodiments, the dump body lifting assembly is an underbody hoist actuator assembly.

In some embodiments, the at least one mount is C-shaped.

In some embodiments, the at least one mount is adapted to slidingly receive the connecting member of the dump body lifting assembly.

In some embodiments, the channel is open-ended in a direction pointing generally towards a rear end of the floor.

In some embodiments, the at least one mount is disposed longitudinally between the front end and the rear end of the floor.

In some embodiments, the truck further includes a lubrication fitting connected to the at least one mount, the lubrication fitting being adapted for injecting lubricant in the channel.

In some embodiments, the truck further includes a safety pin connectable to the at least one mount to close the channel and secure the connecting member of the dump body lifting assembly in the channel when received therein.

In some embodiments, the safety pin is a fastener.

In some embodiments, the at least one mount includes a first mount and a second mount. The channel of the first mount is a first channel. The channel of the second mount is a second channel. The first and second mounts are laterally spaced from each other on the underside of the floor. The connecting member is received in both the first and second channels.

In some embodiments, the truck further includes a first longsill connected to the underside of the floor, and a second longsill connected to the underside of the floor. The first and second longsills are laterally spaced from each other. The first mount is connected to an inwardly facing side of the first longsill. The second mount is connected to an inwardly facing side of the second longsill.

In some embodiments, the truck further includes a hinge assembly including at least one hinge pin, and at least one sill connected to the underside of the floor, the at least one sill defining an aperture dimensioned for receiving the at least one hinge pin therein.

In some embodiments, the at least one sill defines a lubrication port.

In some embodiments, the at least one sill is two sills.

In accordance with yet another aspect of the present technology, there is provided a method of assembling a dump body to a subframe of a truck. The method includes inserting at least one hinge pin through at least one sill connected to the dump body and at least one hinge bracket connected to the subframe, and sliding a connecting member of a dump body lifting assembly in a channel defined by at least one mount connected to an underside of a floor of the dump body.

In some embodiments, the method further includes connecting a safety pin to the at least one mount for securing the connecting member in the channel.

In some embodiments, the at least one mount includes a first mount and a second mount. The channel of the first mount is a first channel. The channel of the second mount is a second channel. The first and second mounts are laterally spaced from each other on the underside of the floor, and the connecting member is slid simultaneously in the first and second channels.

In some embodiments, sliding the connecting member includes sliding the connecting member from an open end of the channel to a closed end of the channel until the connecting member abuts the closed end.

In some embodiments, the open end of the channel faces generally toward a rear of the dump body.

For the purposes of the present application, terms related to spatial orientation such as front, rear, left and right should be understood as they would normally be understood by a driver of a truck having a dump body sitting in the truck in a normal driving position with the dump body in a lowered position.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view taken from a front, top, left side of a truck having a subframe connected to a chassis thereof, a dump body pivotally connected to the subframe using a hinge assembly, and a dump body lifting assembly connected between the subframe and the dump body, with the dump body pivoted in a raised position;

FIG. 2 is a cross-sectional view taken along a longitudinal center plane of the subframe, hinge assembly, dump body lifting assembly and dump body of FIG. 1;

FIG. 3 is a perspective view taken from a front, top, left side of the components of FIG. 2;

FIG. 4 is an enlarged left side elevation view of a mount of the dump body;

FIG. 5 is a close-up view of portion 5 of FIG. 3;

FIG. 6 is a perspective view taken from a front, bottom, left side of a rear portion of the dump body of FIG. 1;

FIG. 7 is a close-up perspective view taken from a front, top, left side of a sill of the hinge assembly of FIG. 1;

FIG. 8 is a perspective view taken from a top, left side of the subframe, hinge assembly and dump body lifting assembly of FIG. 1, with the dump body lifting assembly in the retracted position;

FIG. 9 is a partially exploded, perspective view taken from a top, rear, right side of the components of FIG. 8, with the subframe connected to the chassis of the truck of FIG. 1;

FIG. 10 is a close-up view of portion 10 of FIG. 9; and

FIG. 11 is a flowchart of a method of assembling a dump body to a subframe.

### DETAILED DESCRIPTION

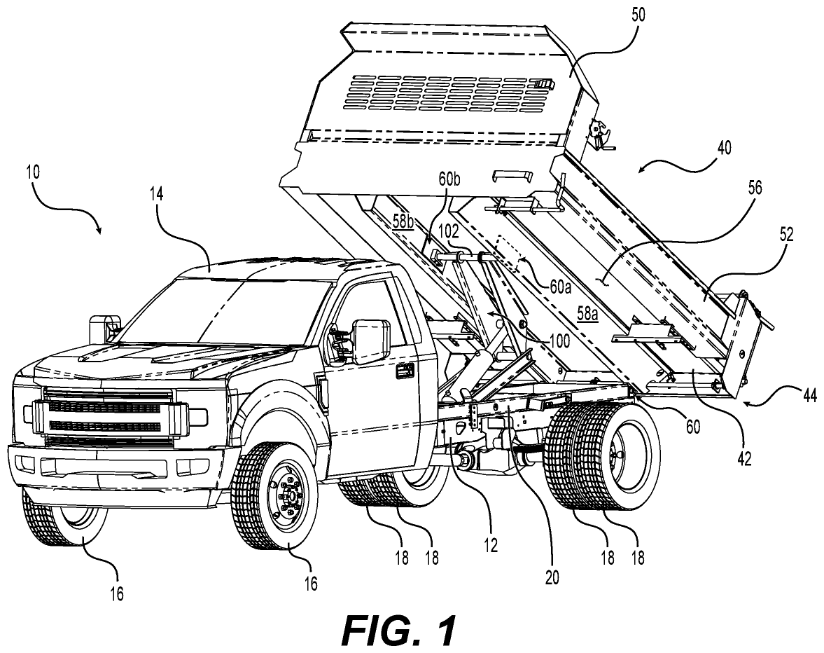

FIG. 1 illustrates an embodiment of a truck 10. The truck 10 has a chassis 12. A cab 14 is connected to a front of the chassis 12. Two steerable front wheels 16 are rotatably connected to the chassis 12 at a front thereof. Four rear wheels 18 (two on the right, two on the left) are rotatably connected to the chassis 12 at a rear thereof. It is contemplated that the truck 10 could have more or less wheels than described above. The above description of a truck 10 is only one possible embodiment of a truck.

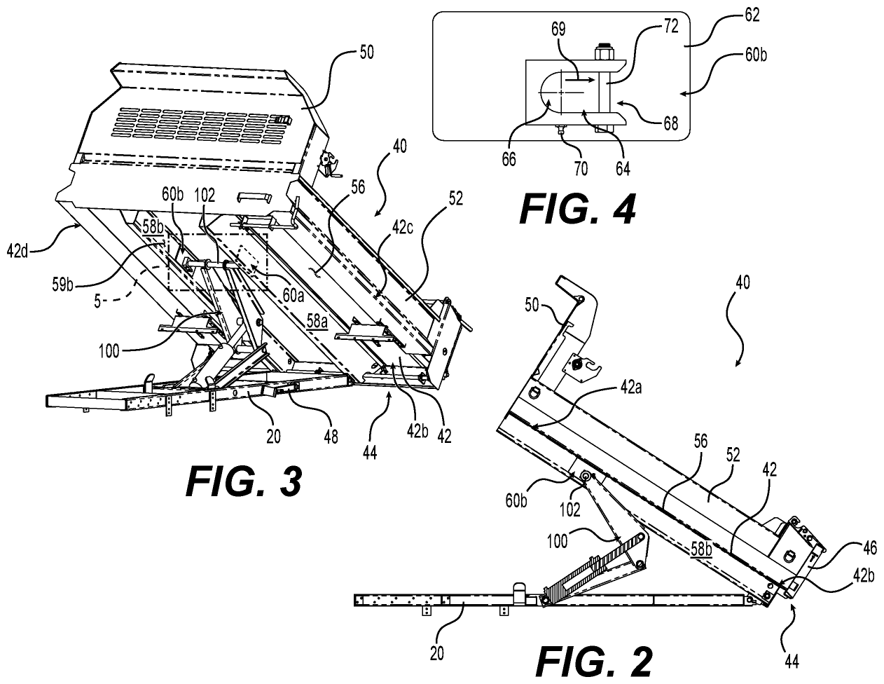

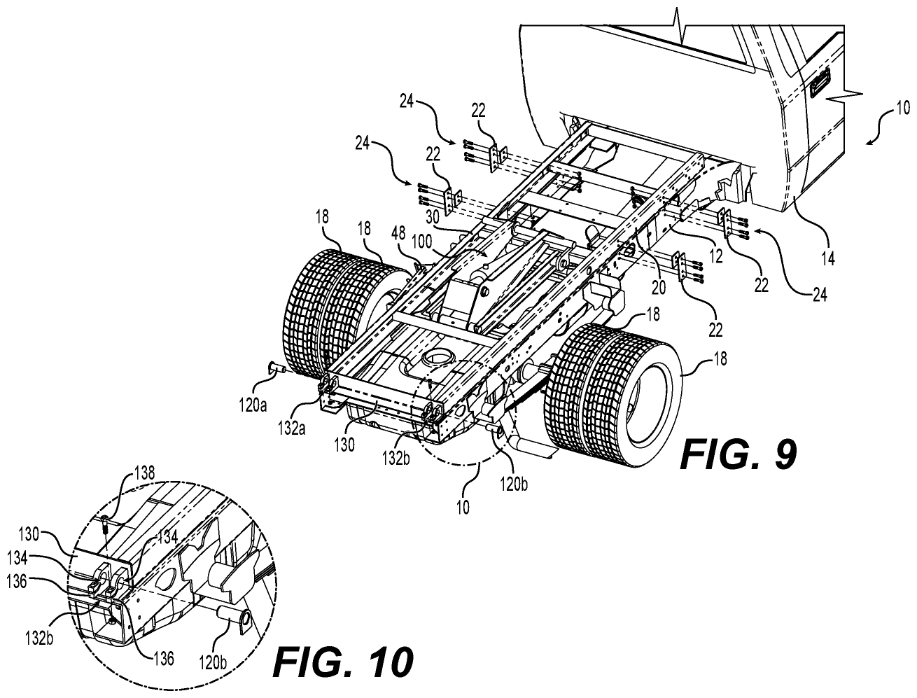

Still referring to FIG. 1, a subframe 20 is connected to the chassis 12. As best seen in FIG. 9, the subframe 20 is connected to the chassis 12 using connection plates 22 and fasteners 24. In other embodiments, U-bolts could be used to connect the subframe 20 to chassis 12. The subframe 20 includes left and right laterally spaced longitudinal support structures 30 (FIGS. 8 and 9) that are adapted for supporting a dump body 40. The subframe 20 and its connection to the chassis 12 could differ in other embodiments. The dump body 40 is pivotally connected to the subframe 20 using a hinge assembly 60. The hinge assembly 60 is connected to a floor 42 of the dump body 40 at a rear end 44 thereof via longsills 58a, 58b as will be described in more detail below. The hinge assembly 60 is also located at the rear of the subframe 20. The dump body 40 has an opening (not shown) defined at the rear end 44 thereof. The opening provides access to an interior of the dump body 40. A tailgate 46 (FIG. 2) is pivotally connected to the dump body 40. The tailgate 46 selectively closes the opening, and thus selectively provides access to the interior of the dump body 40. The dump body 40 can pivot between a lowered position and a raised position (shown in FIGS. 1 and 3). In the raised position, the dump body 40 can empty its content through the rear opening thereof when the tailgate 46 is moved in an open or partially open position. A dump body lifting assembly 100 is pivotally connected between the subframe 20 and the floor 42 of the dump body 40. The dump body lifting assembly 100 can extend to pivot the dump body 40 to the raised position, and can retract (as shown in FIGS. 8 and 9) to return the dump body 40 to the lowered position. In the present embodiment, the dump body lifting assembly 100 is an underbody hoist actuator assembly, but other types of dump body lifting assemblies could be used in other embodiments. A safety prop 48 (FIGS. 3 and 8) is pivotally connected to the subframe 20 and can be raised to support the dump body 40 in the raised position. When not needed, the safety prop 48 is pivoted downwards in the stowed position, as shown in FIGS. 1, 3 and 8.

Referring now to FIGS. 1 to 3, the dump body 40 will be described in more details. The floor 42 has a front end 42a and a rear end 42b. The dump body 40 has a front wall 50 projecting upwardly from the front end 42a of the floor 42. The dump body 40 further has a left side wall 52 projecting upwardly from a left side 42c of the floor 42, and a right side wall projecting upwardly from a right side 42d of the floor 42. The floor 42 further has an underside 56. Two longsills 58a, 58b are connected to the underside 56 of the floor 42. The longsills 58a, 58b are laterally spaced from one another. In other embodiments, the longsills 58a, 58b could be omitted, a single longsill could be provided, or more than two longsills could be provided.

Referring to FIGS. 3 to 5, the dump body 40 further has a mount 60a (schematically shown) and a mount 60b connected to the underside 56 of the floor 42. The mounts 60a, 60b are disposed longitudinally between the front end 42a and the rear end 42b of the floor 42. More particularly, the mounts 60a, 60b are connected to the bottom surfaces of the longsills 58a, 58b respectively. The mount 60a is connected to an inwardly facing side (not shown) of the longsill 58a, and the mount 60b is connected to an inwardly facing side 59b of the longsill 58b. In other words, the mounts 60a, 60b are laterally spaced from each other on the underside 56 of the floor 42, and face each other. As the mount 60a is a mirror image of the mount 60b, the following description of the mount 60b applies to the mount 60a.

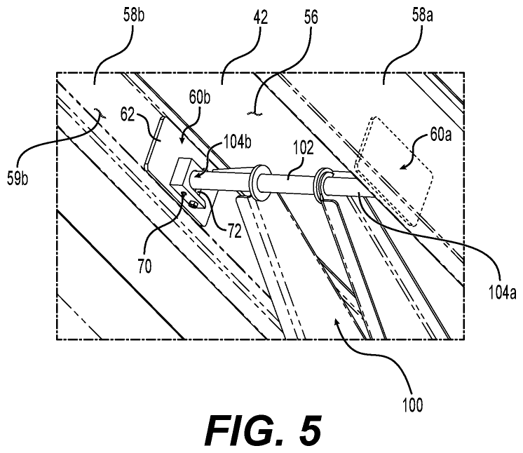

Still referring to FIGS. 3 to 5, the mount 60b includes a plate 62 connected to the longsill 58b. The plate 62 could be omitted in certain embodiments. As best seen in FIG. 4, the mount 60b generally has a C-shape. The mount 60b defines a channel 64 having a closed end 66 and an open end 68. The channel 64 is open-ended in a direction 69 pointing generally towards the rear end 42b of the floor 42 when the mount 60b is connected to the longsill 58b. The channel 64 is adapted for receiving a connecting member 102 of the dump body lifting assembly 100. In the present embodiment, the connecting member 102 is a cylindrical bar, and the channel 64 is dimensioned for slidingly receiving an end portion 104b of the connecting member 102. In other words, the end portion 104b of the connecting member 102 is received in the open end 68 of the channel 64 and slid towards the closed end 66 until the end portion 104b abuts the closed end 66 of the channel 64, as shown in FIG. 5.

Since the mount 60a is similar to the mount 60a and is facing the mount 60b, the opposite end portion 104a of the connecting member 102 is also received in the open end 68 of the channel 64 defined by the mount 60a, and slid towards the closed end 66 of the channel 64 simultaneously with the end portion 104b being received in the mount 60b. Thus, the end portions 104a, 104b of the connecting member 102 are received in the respective channel 64 of the mount 60a and the mount 60b.

The shape and dimensions of the connecting member 102 could differ in other embodiments, and the channel 64 could be shaped and dimensioned to receive such differing connecting member 102. It is also contemplated that only one mount could be used instead of the mounts 60a, 60b of the present embodiment. For example, the mount could be located in a central region of the floor 42, and project downwardly from the underside 56 of the floor 42 to receive and engage a central portion of the connecting member 102. It is also contemplated that the mounts 60a, 60b could be configured otherwise, and could define, for example, channels 64 being open ended in a direction pointing generally downward.

Still referring to FIGS. 3 to 5, lubrication fittings 70 are connected to the mounts 60a, 60b. Each lubrication fitting 70 is adapted for injecting lubricant in the corresponding channel 64, and thus reduce friction between the end portions 104a, 104b of the connecting member 102 and their corresponding mount 60a, 60b. Furthermore, a safety pin 72 is connectable to each one of the mounts 60a, 60b to close the channel 64 and secure the connecting member 102 in the channel 64 when received therein. In the present embodiment, the safety pins 72 are fasteners, more specifically nuts and bolts. The safety pins 72 can prevent the end portions 104a, 104b of the connecting member 102 from exiting the channels 64 unexpectedly. For example, in a situation where the dump body 40 is held in the raised position by the safety prop 48 and the dump body lifting assembly 100 is drawn to the retracted position, the safety pins 72 would keep the end portions 104a, 104b of the connecting member 102 received in their corresponding mounts 60a, 60b.

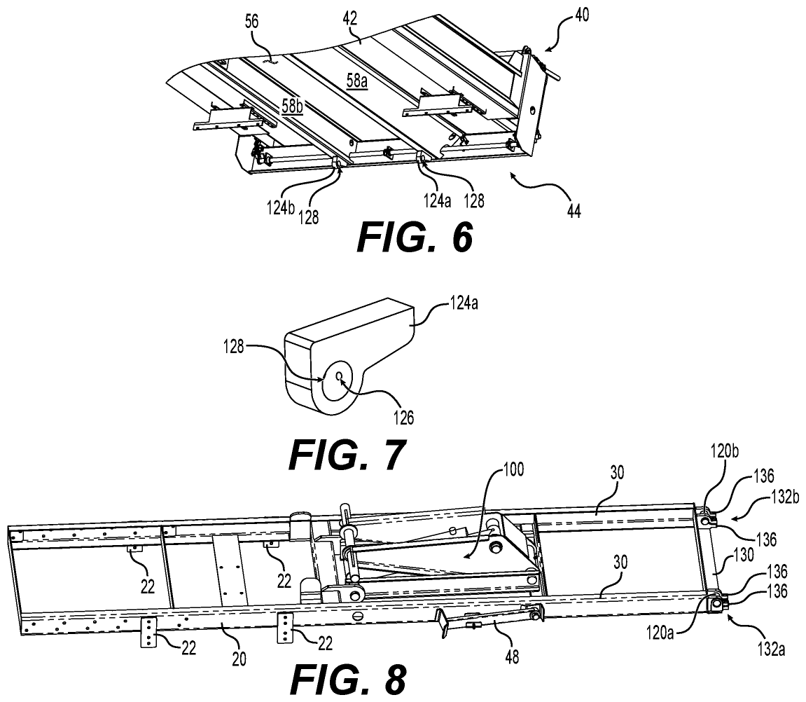

Referring now to FIGS. 6 to 10, the hinge assembly 60 will be described. The hinge assembly 60 pivotally connects the rear of the subframe 20 to the rear end 44 of the floor 42 of the dump body 40. The hinge assembly 60 includes hinge pins 120a, 120b. In other embodiments, the hinge pins 120a, 120b could be replaced by a single hinge pin, or there could be more than two hinge pins. In the present embodiment, the hinge pins 120a, 120b are identical. Sills 124a, 124b are connected to the underside 56 of the floor 42 using suitable bonding techniques, such as welding. More particularly, in the present embodiment, the sills 124a, 124b are connected to the longsills 58a, 58b respectively as seen in FIG. 6. Each one of the sills 124a, 124b defines a lubrication port 126 that is used to inject lubricant in the hinge assembly 60. In addition, each one of the sills 124a, 124b defines an aperture 128 dimensioned for receiving the corresponding one of the hinge pins 120a, 120b. In the present embodiment, the sills 124a, 124b are identical.

Referring to FIGS. 8 to 10, the hinge assembly 60 further includes a cross member 130 spanning laterally between the laterally spaced longitudinal support structures 30. The cross member 130 is also connected to both the laterally spaced longitudinal support structures 30. The hinge assembly 60 further includes hinge brackets 132a, 132b connected to the cross member 130. The hinge brackets 132a, 132b are structured and configured for receiving the corresponding one of the sills 124a, 124b. Each of the hinge brackets 132a, 132b defines apertures 134 (FIG. 10) dimensioned for receiving the corresponding one of the hinge pins 120a, 120b. The hinge brackets 132a, 132b further include tabs 136 adapted to receive therein a fastener 138 (FIG. 10). In the present embodiment, the hinge brackets 132a, 132b are identical.

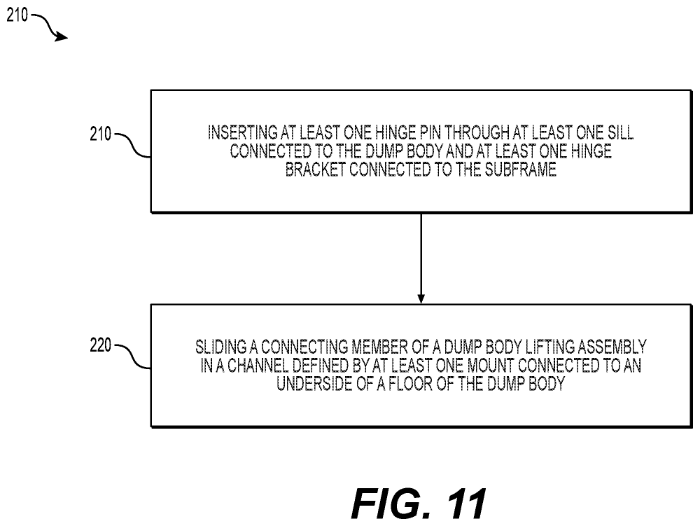

Referring to FIG. 11, an illustrative scenario will now be provided to describe a method 200 of assembling the dump body 40 to the subframe 20. At step 210, the method 200 includes inserting the hinge pins 120a, 120b through the sills 124a, 124b, respectively, and through the hinge brackets 132a, 132b, respectively. With reference to FIG. 10, the assembly of the hinge bracket 132b, hinge pin 120b and sill 124b will be described, and since these components are identical to the hinge bracket 132a, hinge pin 120a and sill 124a respectively, the assembly of these components will not be described.

The cross member 130 is first connected to the subframe 20. Then, the hinge bracket 132b is connected to the cross member 130. If that was not the case, the sill 124b is connected to the underside 56 of the floor 42 of the dump body 40. It is to be noted that the order of these steps could differ. The dump body 40 is then positioned relative to the subframe 20 such that the aperture 128 of the sill 124b is coaxial with the apertures 134 of the hinge bracket 132b. The hinge pin 120b is then inserted through the apertures 128, 134, thereby pivotally connecting the dump body 40 to the subframe 20. The fastener 138 is then inserted in the corresponding tabs 136 and tightened therein to secure the hinge pin 120b to the hinge bracket 134b.

The method 200 further includes step 220 that includes sliding the connecting member 102 of the dump body lifting assembly 100 in the channels 64 defined by the mounts 60a, 60b connected to the underside 56 of the floor 42 of the dump body 40. As described above, the step 220 involves receiving each one of the end portions 104a, 104b of the connecting member 102 in the corresponding open end 68 of the channel 64 of the corresponding mount 60a, 60b, and sliding simultaneously the end portions 104a, 104b towards the closed end 66 of the channel 64 of the corresponding mount 60a, 60b until the connecting member 102 abuts the closed end 66 of the channel 64 of the corresponding mount 60a, 60b. The safety pins 72 are then connected to the mounts 60a, 60b for securing the connecting member 102 received in the channel 64 of each mount 60a, 60b.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

What is claimed is:

1. A dump body comprising:
a floor;
a front wall projecting upwardly from a front end of the floor;
a left side wall projecting upwardly from a left side of the floor;
a right side wall projecting upwardly from a right side of the floor; and
at least one mount connected to an underside of the floor, the at least one mount defining a channel having an open end, the channel being adapted for receiving a connecting member of a dump body lifting assembly.

2. The dump body of claim 1, wherein the at least one mount is C-shaped.

3. The dump body of claim 1, wherein the at least one mount is adapted to slidingly receive the connecting member of the dump body lifting assembly.

4. The dump body of claim 1, wherein the channel is open-ended in a direction pointing generally towards a rear end of the floor.

5. The dump body of claim 1, wherein the at least one mount is disposed longitudinally between the front end and the rear end of the floor.

6. The dump body of claim 1, further comprising a lubrication fitting connected to the at least one mount, the lubrication fitting being adapted for injecting lubricant in the channel.

7. The dump body of claim 1, further comprising a safety pin connectable to the at least one mount to close the channel and secure the connecting member of the dump body lifting assembly in the channel when received therein.

8. The dump body of claim 7, wherein the safety pin is a fastener.

9. The dump body of any one of claims 1 to 8, wherein:
the at least one mount includes a first mount and a second mount,
the channel of the first mount being a first channel,
the channel of the second mount being a second channel,
the first and second mounts being laterally spaced from each other on the underside of the floor, and
the connecting member is received in both the first and second channels.

10. The dump body of claim 9, further comprising:
a first longsill connected to the underside of the floor; and
a second longsill connected to the underside of the floor;
wherein:
the first and second longsills are laterally spaced from each other;
the first mount is connected to an inwardly facing side of the first longsill; and
the second mount is connected to an inwardly facing side of the second longsill.

11. The dump body of any one of claims 1 to 8, further comprising a hinge assembly including:
at least one hinge pin; and
at least one sill connected to the underside of the floor, the at least one sill defining an aperture dimensioned for receiving the at least one hinge pin therein.

12. The dump body of claim 11, wherein the at least one sill defines a lubrication port.

13. The dump body of claim 11, wherein the at least one sill is two sills.

14. A truck comprising:
a chassis;
a cab connected to the chassis;
a plurality of wheels rotatably connected to the chassis;
a subframe connected to the chassis, the subframe having at least one hinge bracket;
a dump body pivotally connected to the subframe at a rear thereof, the dump body comprising:
a floor;
a front wall projecting upwardly from a front end of the floor;
a left side wall projecting upwardly from a left side of the floor;
a right side wall projecting upwardly from a right side of the floor; and
at least one mount connected to an underside of the floor, the at least one mount defining a channel having an open end; and
a dump body lifting assembly operatively connected between the subframe and the dump body for pivoting the dump body relative to the subframe, the dump body lifting assembly having a connecting member received in the channel of the at least one mount.

15. The truck of claim 14, wherein the dump body lifting assembly is an underbody hoist actuator assembly.

16. The truck of claim 14, wherein the at least one mount is C-shaped.

17. The truck of claim 14, wherein the at least one mount is adapted to slidingly receive the connecting member of the dump body lifting assembly.

18. The truck of claim 14, wherein the channel is open-ended in a direction pointing generally towards a rear end of the floor.

19. The truck of claim 14, wherein the at least one mount is disposed longitudinally between the front end and the rear end of the floor.

20. The truck of claim 14, further comprising a lubrication fitting connected to the at least one mount, the lubrication fitting being adapted for injecting lubricant in the channel.

21. The truck of claim 14, further comprising a safety pin connectable to the at least one mount to close the channel and secure the connecting member of the dump body lifting assembly in the channel when received therein.

22. The truck of claim 21, wherein the safety pin is a fastener.

23. The truck of any one of claims 14 to 22, wherein:
the at least one mount includes a first mount and a second mount,
the channel of the first mount being a first channel,
the channel of the second mount being a second channel,
the first and second mounts being laterally spaced from each other on the underside of the floor, and
the connecting member is received in both the first and second channels.

24. The truck of claim 23, further comprising:
a first longsill connected to the underside of the floor; and
a second longsill connected to the underside of the floor;
wherein:
the first and second longsills are laterally spaced from each other;
the first mount is connected to an inwardly facing side of the first longsill; and
the second mount is connected to an inwardly facing side of the second longsill.

25. The truck of any one of claims 14 to 22, further comprising a hinge assembly including:
at least one hinge pin; and
at least one sill connected to the underside of the floor, the at least one sill defining an aperture dimensioned for receiving the at least one hinge pin therein.

26. The truck of claim 25, wherein the at least one sill defines a lubrication port.

27. The truck of claim 25, wherein the at least one sill is two sills.

28. A method of assembling a dump body to a subframe of a truck, comprising:
inserting at least one hinge pin through at least one sill connected to the dump body and at least one hinge bracket connected to the subframe; and
sliding a connecting member of a dump body lifting assembly in a channel defined by at least one mount connected to an underside of a floor of the dump body.

29. The method of claim 28, further comprising connecting a safety pin to the at least one mount for securing the connecting member in the channel.

30. The method of claim 28, wherein:
the at least one mount includes a first mount and a second mount,
the channel of the first mount being a first channel,
the channel of the second mount being a second channel,
the first and second mounts are laterally spaced from each other on the underside of the floor, and the connecting member is slid simultaneously in the first and second channels.

31. The method of any one of claims 28 to 30, wherein sliding the connecting member comprises sliding the connecting member from an open end of the channel to a closed end of the channel until the connecting member abuts the closed end.

32. The method of claim 31, wherein the open end of the channel faces generally toward a rear of the dump body.
